(19) United States
(12) Patent Application Publication
(10) Pub. No.: US 2005/0246362 A1
(43) Pub. Date: Nov. 3, 2005

(54) System and method for dynamci log compression in a file system

(76) Inventor: Devin P. Borland, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/837,774

(22) Filed: May 3, 2004

(51) Int. Cl. G06F 17/30

(52) U.S. Cl. 707/101

(57) ABSTRACT

A method for log compression in a file system comprises receiving a log input and writing the log input to a transaction log file in a statistically-determined compression format.

### TECHNICAL FIELD

The present invention relates generally to the field of file systems, and more particularly to a system and method for dynamic log compression in a file system.

### BACKGROUND

Certain file systems, such as AdvFS (Advanced File System), VXFS (VERITAS File System), JFS (Journaled File System), and/or the like, require metadata updates related to the file change be logged when a change to a file is made. Each time a file, for example a system or user file, is updated, metadata update related to the file update is logged in a transaction log file. Any changes to the metadata that manages the updated file are logged. However, the log file has a finite capacity. As the log file is filled, the logged data is incrementally transferred from the file system to a storage device for data persistence in the event of a system failure. The transfer of data of the log file from the file system to the storage device requires an input-output operation which slows down the operation of the file system.

### SUMMARY

In accordance with an embodiment of the present invention, a method for log compression in a file system comprises receiving a log input and writing the log input to a transaction log file in a statistically-determined compression format.

In accordance with another embodiment of the present invention, a method for log compression in a file system comprises receiving a log input and writing the log input in a statistically-determined compression format to a transaction log file if a size of the compressed log input is less than a size of the log input in an uncompressed format.

In accordance with another embodiment of the present invention, a system comprises application logic operable to receive a log input and write the log input to a transaction log file in a statistically-determined compression format.

In accordance with another embodiment of the present invention, method for log compression in a file system comprises statistically determining a compression format for compressing at least one of a plurality of received log inputs in the file system and automatically changing the statistically-determined compression format if a frequency of occurrence of values associated with the plurality of received log inputs exceeds a predetermined threshold.

### BRIEF DESCRIPTION OF THE DRAWINGS

For a more complete understanding of embodiments of the present invention, the objects and advantages thereof, reference is now made to the following descriptions taken in connection with the accompanying drawings in which:

FIG. 1 is a block diagram of a system in accordance with an embodiment of the present invention;

FIG. 2 is a flowchart of a method for updating a transaction log file in accordance with an embodiment of the present invention; and

FIG. 3 is a flowchart of a method for statistical log compression in accordance with an embodiment of the present invention.

### DETAILED DESCRIPTION OF THE DRAWINGS

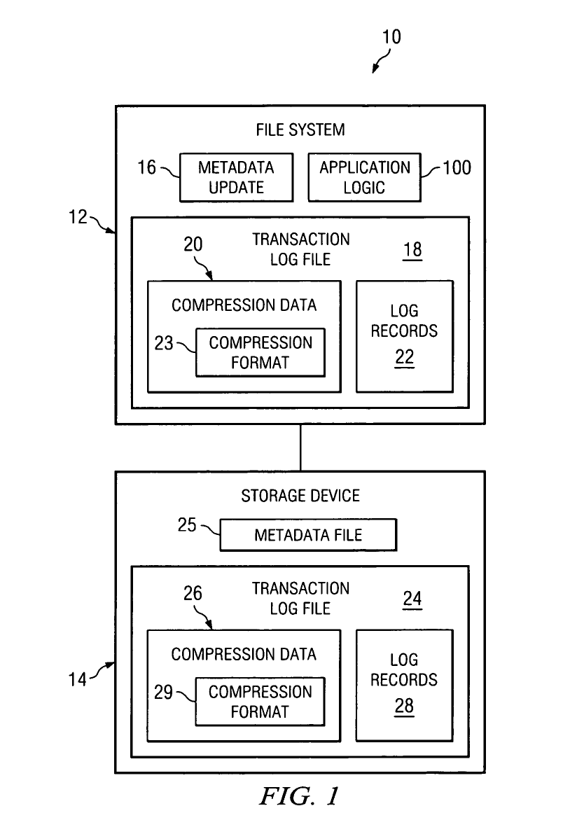

The preferred embodiment of the present invention and its advantages are best understood by referring to FIGS. 1 through 3 of the drawings.

FIG. 1 is a block diagram of a system 10 in accordance with an embodiment of the present invention. System 10 comprises a file system 12 and a storage device 14 associated with file system 12. File system 12 comprises a transaction log file 18. Transaction log file 18 comprises a plurality of log records 22 and has compression data 20 associated with it. For example, compression data 20 comprises information associated with a scheme or method of compressing/decompressing log records 22. In the embodiment illustrated in FIG. 1, compression data 20 comprises a compression format 23 for compressing/decompressing log records 22. Preferably, compression format 23 comprises a statistically-determined method of data compression such as, but not limited to, a Huffman compression trie, such that an entire log record is compressed based on a statistical analysis of the log record(s). For example, in some embodiments, a statistically-determined compression format 23 is derived by analyzing the log record(s) 22 and transforming the code characters used for the log record(s) with symbols or binary values based on the frequency or occurrence of such code characters. Preferably, the statistically-determined compression format 23 is derived by statistically analyzing a predetermined quantity of log records 22 such that a frequency distribution is obtained for the predetermined quantity of log records 22. The frequency distribution for the predetermined quantity of log records 22 is used to determine an optimum compression format 23 for the log records 22 based on the statistical analysis of the log records 22. However, it should be understood that other data compression methods may be used. Each of the records in log records 22 may be of the same or different sizes.

Storage device 14 may be any storage device now known or later developed. Storage device 14 comprises a transaction log file 24 and at least one metadata file 25. Transaction log file 24 comprises compression data 26 and a plurality of log records 28. Compression data 26 comprises information associated with compression/decompression of log records 28. As will be described further below, compression data 26 comprises information received from file system 12 corresponding to compression data 20 to enable decompression of log records 28. Thus, for example, compression data 26 comprises a compression format 29 corresponding to compression format 23 of file system 12. Each of the records in log records 28 may be of the same or different sizes. Metadata file 25 comprises information on files stored in storage device 14.

In operation, in response to an update of a file (e.g., a system or user file), metadata update 16 related to the updated file is logged in transaction log file 18 of file system 12 as one of the log records 22. In some embodiments of the present invention, if appropriate, metadata update 16 is compressed before being written into log records 22. For example, in some embodiments, a comparison is performed between a compressed format of the metadata update 16 and an uncompressed format of the metadata update 16. If the compressed format of the metadata update 16 is smaller than the uncompressed format of the metadata update 16, the metadata update 16 is compressed and stored as log record 22. Conversely, if the uncompressed format of the metadata update 16 is smaller than the compressed format of the metadata update 16, metadata update 16 is stored as log record 22 in an uncompressed format. The mapping for compressing the metadata is provided by compression data 20 (e.g. compression format 23). Thus, compression of metadata update 16 prior to being written into log records 22, when appropriate, enables a greater number of log records to be written into transaction log file 18.

In operation, data from log records 22 is periodically transferred from file system 12 to storage device 14 and copied into log records 28 of storage device 14. Transfer of the log records from file system 12 to storage device 14 maintains data persistence in the event of a system failure. Because of the compression of metadata update 16 before being written into transaction log file 18 of file system 12, the frequency of such transfers is reduced because metadata updates 16 related to a greater number of file updates may be logged into transaction log file 18, thereby improving the performance of system 10 by reducing the quantity of input-output operations of system 10. Also, in some embodiments, because at least some of the metadata updates 16 are transferred in a compressed format, the actual amount of data transferred from file system 12 to storage device 14 is also reduced, thereby further improving performance of system 10. Information in log records 28 is used to update metadata file 25.

In some embodiments, system 10 is also configured to automatically modify or change compression format 23. For example, in some embodiments, statistics relating to the frequency of occurrence of values associated with log inputs to transaction log file 18 are monitored and/or analyzed. In response to a predetermined change in the frequency, compression format 23 is automatically modified to provide an optimal compression format for metadata updates 16. In some embodiments, system 10 is configured to maintain a single compression format 23 for compressing metadata updates 16, thereby conserving memory capacity. For example, in some embodiments, in response to the frequency of the occurrences of values associated with log inputs to transaction log file 28 exceeding a predetermined threshold, compression of metadata updates 16 at file system 12 is suspended until log records 22 in transaction log file 18 have been processed (e.g., transferred to storage device 14) so that metadata file 25 in storage device 14 has been updated. Thus, after update of metadata file 25 in storage device 14, log records 28 and compression format 29 may be erased or otherwise purged from storage device 14 because after update of metadata file 25 in storage device 14, log records 28 are no longer needed. Therefore, after processing of log records 22 from file system 12, a new compression format 23 is determined, generated or otherwise identified for compressing future log records 22. Accordingly, after a new compression format 23 has been implemented or otherwise identified, the new compression format 23 is stored in storage device 14 and compression of log records 22 is re-enabled.

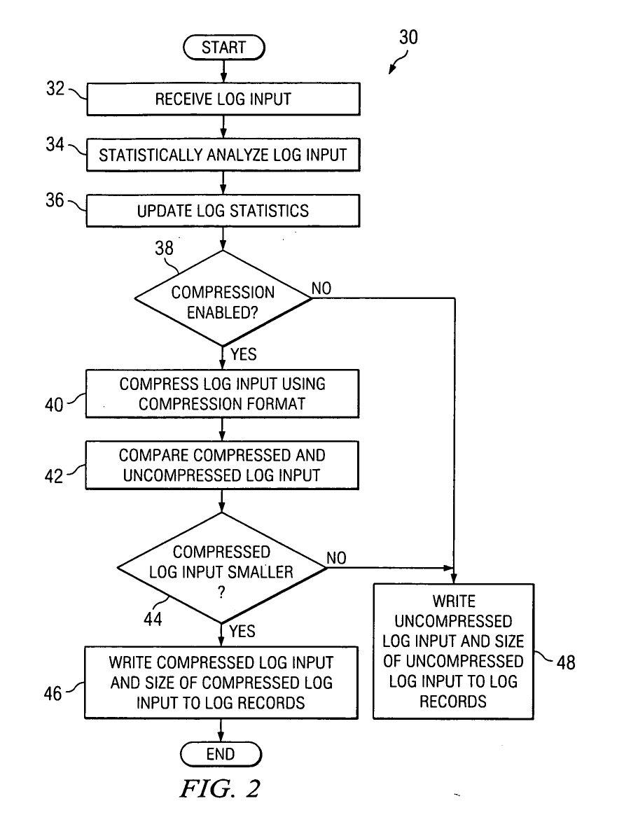

FIG. 2 is a flowchart of a dynamic log compression method 30 for updating transaction log file 18 in accordance with an embodiment of the present invention. At block 32, a log input to be recorded in transaction log file 18 is received. The log input may be, for example, a metadata update, such as information on updates to be made to a file. In an exemplary embodiment, the size of the log input that is received at block 32 varies from one log input to another. If desired, the size of the log input may be fixed. At block 34, the received log input is statistically analyzed. For example, in some embodiments, the log input is divided into n-bit segments and the value of each segment is determined. Each segment may have a value from 0 to 2ⁿ−1. For example, if the value of n is 8, then each segment may have a value from 0 to 255.

In some embodiments, statistics regarding the frequency of occurrence of the values in the log inputs are tracked. For example, in some embodiments of the present invention, the log statistics are used for statistical or dynamic log compression. At block 36, log statistics are updated based on the results of block 34. Table I is an exemplary log statistics table. In an exemplary embodiment, at block 36, the frequency of occurrence of each segment in the received log input is added to the current statistics.

TABLE I
Log Statistics Table

| VALUE | FREQUENCY |
|---|---|
| 0 | f(0) |
| 1 | f(1) |
| 2 | f(2) |
| . | . |
| . | . |
| . | . |
| 2ⁿ − 1 | f(2ⁿ − 1) |

At block 38, a determination is made as to whether log compression is enabled. If log compression is not enabled, then the process starting at block 48 is executed, where the uncompressed log input along with the size of the uncompressed log input is written into log records 22. If at block 38 it is determined that log compression is enabled, then the process starting at block 40 is executed, where the log input is compressed using compression format 23. In some embodiments, the log input is compressed by replacing at least one n-bit segment with a corresponding segment of less than n-bits corresponding to the compression format 23.

At block 42, a size of a compressed log input is compared to a size of an uncompressed log input. At block 44, a determination is made as to whether the size of the compressed log input is less than the size of the uncompressed log input. If the size of the compressed log input is not smaller than the size of the uncompressed log input, the process proceeds to block 48, where the uncompressed log input along with the size of the uncompressed log input is written into log records 22. If the size of the compressed log input is smaller than the size of the uncompressed log input, the process proceeds to block 46, where the compressed log input along with the size of the compressed log input is written into log records 22. In some embodiments, the compressed log input is written into log records 22 with an indicator indicating that the log input is compressed. In some embodiments, the indicator comprises a negative value for the size of the compressed log input. The negative value of the size of the compressed log input is used to indicate that the log input is in compressed form. The method then terminates or is otherwise repeated for additional log inputs.

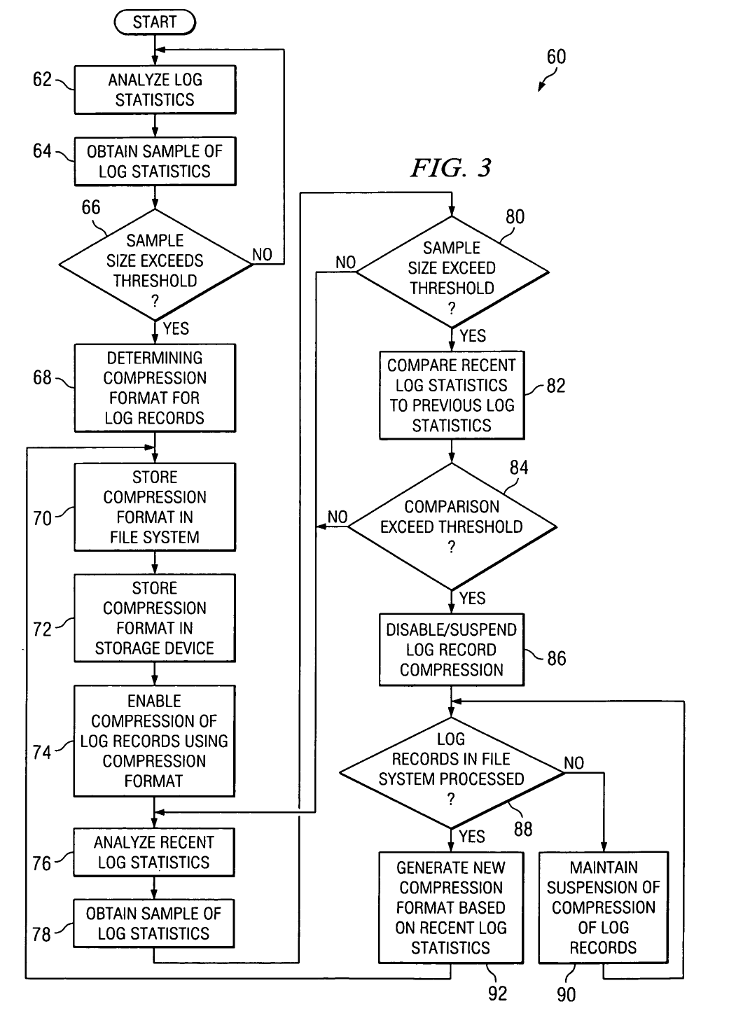

FIG. 3 is a flowchart of a method 60 for dynamic statistical log compression in accordance with an embodiment of the present invention. At block 62, the log statistics are analyzed. For example, in some embodiments, log statistics comprise a frequency of occurrence of the statistical values in the log inputs. At block 64, a sample of the log statistics is obtained to determine whether a sufficient quantity of log statistics have been obtained to establish a frequency model for the log statistics. For example, in some embodiments, particular values of the log inputs occur with greater frequency than other values of the log inputs. Thus, over time, a frequency model may be determined for the values of the log statistics. In some embodiments, a sample size is the sum of the frequencies for the values of the segments of the log inputs stored in the log statistics table.

At block 66, a determination is made as to whether the sample size exceeds a minimum or predetermined threshold. The threshold value may be user-configurable or predefined. In some embodiments, the threshold value is selected based on one or more of the following factors—the value of n, processing time to be devoted to computing a compression trie, etc. In operation, it is desirable that the compression format 23 be determined when a desirable amount of data or information is available (e.g., sufficient quantity of log statistics to obtain frequency model of the log static values). Therefore, if at block 66, it is determined that the sample size is not greater than the minimum threshold, then the process proceeds to block 62, where log statistics continue to be analyzed. If the sample size does not exceed the threshold at block 66, the method proceeds to block 68, where compression format 23 is determined or otherwise generated for compressing log records 22. Any method now known or later developed for generating compression format 23 may be used. For example, in some embodiments, a statistical trie based at least in part on the frequency of the segments of the log inputs may be used to determine the compression format 23. Compression format 23 provides a mapping for replacing n-bits of data with data whose size may be more or less than n-bits. Table II is an exemplary compression format 23 as a statistical trie for n=4.

TABLE II
Compression Trie

| SEGMENT TO | | REPLACING |
|---|---|---|
| BE REPLACED | FREQUENCY | SEGMENT |
| 0000 | 100 | 1 |
| 0001 | 50 | 011 |
| 0010 | 20 | 00011 |
| 0011 | 5 | 010011 |
| 0100 | 5 | 000001 |
| 0101 | 4 | 010000 |
| 0110 | 8 | 000100 |
| 0111 | 11 | 00001 |
| 1000 | 1 | 00000000 |
| 1001 | 12 | 0101 |
| 1010 | 8 | 000101 |
| 1011 | 4 | 010001 |
| 1100 | 3 | 0000001 |
| 1101 | 4 | 010010 |
| 1110 | 2 | 00000001 |
| 1111 | 70 | 001 |

At block 70, the computed or otherwise generated compression format 23 is stored in file system 12. At block 72, compression format 23 is stored in storage device 14 as compression format 29. At block 74, compression of log records 22 is enabled using compression format 23.

At block 76, recent log statistics are analyzed. For example, in some embodiments, recent log statistics comprise the log statistics occurring after generation of compression format 23. However, it should be understood that analysis of recent log statistics may comprise an analysis of a portion of log statistics used to obtain compression format 23 and log statistics occurring after determining compression format 23. At block 78, a sample of the recent log statistics is obtained to determine whether a sufficient quantity of recent log statistics have been obtained to establish a frequency model for the recent log statistics. At block 80, a determination is made as to whether the sample size exceeds a minimum or predetermined threshold. As described above, the threshold value may be user-configurable or predefined and may be selected based on one or more of the following factors—the value of n, processing time to be devoted to computing a compression trie, etc. If at block 80, it is determined that the sample size is not greater than the minimum threshold, then the method proceeds to block 76, where log statistics continue to be analyzed. If the sample size does exceed the threshold at block 80, the method proceeds to block 82, where recent log statistics are compared to previous log statistics. For example, the comparison is made to determine whether the recent log statistics are significantly different from the statistics previously used to determine compression format 23. Any method now known or later developed may be used for this determination. For example, in an exemplary embodiment, a weighted mean of the frequency of the values is calculated and compared to a previously calculated weighted mean to determine whether the statistics are significantly different. The determination of whether or not the calculated mean values are significantly different may be based on a user-configured difference value.

At block 84, a determination is made whether a comparison of recent log statistics exceeds a predetermined threshold relative to previous log statistics. If at block 84 it is determined that the recent log statistics do not exceed the threshold relative to previous log statistics, the method proceeds to block 76 where recent log statistics continue to be analyzed and compared to previous log statistics. If the comparison between recent log statistics and previous log statistics does exceed the threshold, the method proceeds to block 86, where compression of log records 22 in file system 12 is disabled or suspended and future log records 22 are written to file system 12 in an uncompressed format. For example, in some embodiments, statistics relating to the frequency of occurrence of values associated with log inputs to transaction log file 18 are monitored and/or analyzed. In response to a predetermined change in the frequency, compression format 23 is automatically modified to provide an optimal compression format for metadata updates 16. In some embodiments, system 10 is configured to maintain a single compression format 23 for compressing metadata updates 16, thereby conserving memory capacity. For example, in some embodiments, in response to the frequency of the occurrences of values associated with log inputs to transaction log file 28 exceeding a predetermined threshold, compression of metadata updates 16 at file system 12 is suspended until log records 22 in transaction log file 18 have been processed (e.g., purged from log file 18 or otherwise transferred to storage device 14) so that metadata file 25 in storage device 14 has been updated. Thus, after update of metadata file 25 in storage device 14, log records 28 and compression format 29 may be erased or otherwise purged from storage device 14 because after update of metadata file 25 in storage device 14, log records 28 are no longer needed. Therefore, after processing of log records 22 from file system 12, a new compression format 23 is determined, generated or otherwise identified for compressing future log records 22. Accordingly, in some embodiments of the present invention, only a single compression format 23 is used for compressing/decompressing log records and, in response to a change in the distribution frequency of statistical values of the log records 22, compression format 23 is modified or otherwise updated to provide an optimum statistically-determined compression scheme for the frequency change, thereby minimizing memory capacity needed to store compression information.

At block 88, a determination is made whether log records 22 in file system 12 have been processed. For example, to facilitate storage of only a single compression format 23, compression of log records 22 is suspended until log records 22 in file system 22 have been processed or transferred to storage device 14, thereby updating metadata file 25 in storage device 14. If a determination is made at block 88 that log records 22 in file system 12 have not yet been processed, the method proceeds to block 90, where a suspension of compression of log records 22 at file system 12 is maintained. The method then proceeds to block 88. If a determination is made at block 88 that log records 22 in file system 12 have been processed, the method proceeds to block 92, where a new compression format 23 is generated based on the recent log statistics. The method then proceeds to block 70 where the new compression format is stored in file system 12 and storage device 14 and compression of log records 22 in file system 12 is re-enabled using the new compression format 23.

As can be seen from the above exemplary table, a particular segment may be replaced with a smaller or larger segment. In an exemplary embodiment, a segment with high frequency is replaced with a smaller segment and a segment with low frequency is replaced with a larger segment. Further, referring to the method depicted in FIG. 3, it should be understood that obtaining samples of log statistics (e.g., blocks 64 and 78) and/or comparing recent log statistics with previous log statistics (e.g., block 82) may be performed on a continuous or periodic basis based on a predetermined or user-configurable interval.

Embodiments of the present invention may be implemented in software, hardware, application logic or a combination of software, hardware and application logic. The software, application logic and/or hardware may reside on storage device 14 or be associated with file system 12. For example, in the embodiment illustrated in FIG. 1, the software, application logic and/or hardware resides on storage device 14 as application logic 100. The application logic, software or an instruction set is preferably maintained on any one of various conventional computer-readable mediums. In the context of this document, a “computer-readable medium” can be any means that can contain, store, communicate, propagate or transport the program for use by or in connection with an instruction execution system, apparatus, or device. The computer-readable medium can be, for example, but is not limited to, an electronic, magnetic, optical, electromagnetic, infrared, or semi-conductor system, apparatus, device, or propagation medium now known or later developed.

If desired, the different functions discussed herein may be performed in any order and/or concurrently with each other. Furthermore, if desired, one or more of the above-described functions may be optional or may be combined.

A technical advantage of an exemplary embodiment of the present invention is that fewer input-output operations are needed. Another technical advantage of an exemplary embodiment of the present invention is that a statistical or dynamic compression scheme is used to compress the log input. The compression scheme used depends on the data being compressed.

1. A method for log compression in a file system, comprising:
receiving a log input; and
writing the log input to a transaction log file in a statistically-determined compression format.

2. The method of claim 1, further comprising writing the log input to the transactional log file with an indicator indicating that the log input is compressed.

3. The method of claim 1, further comprising comparing a compressed format of the log input to an uncompressed format of the log input.

4. The method of claim 1, wherein receiving a log input comprises receiving an update for metadata associated with at least one file of the file system.

5. The method of claim 1, further comprising determining the statistically-determined compression format for the log input based at least in part on a predetermined quantity of received log inputs.

6. The method of claim 1, further comprising dividing the received log input into a plurality of segments.

7. The method of claim 6, further comprising updating log statistics based at least in part on a value of each of the plurality of segments.

8. The method of claim 6, further comprising replacing at least one of the plurality of segments with another segment of smaller size.

9. The method of claim 6, further comprising calculating a value for each of the plurality of segments.

10. The method of claim 1, further comprising determining a frequency of occurrence of values associated with a plurality of received log inputs.

11. The method of claim 1, further comprising automatically changing the statistically-determined compression format for compressing the log input in response to a change in a frequency of occurrence of values associated with a plurality of received log inputs.

12. The method of claim 1, further comprising suspending compression of the log input in response to a frequency of occurrence of values associated with a plurality of received log inputs exceeding a predetermined threshold.

13. The method of claim 1, further comprising statistically analyzing a predetermined quantity of log inputs.

14. The method of claim 1, further comprising automatically changing the statistically-determined compression format after processing of the log input from the transaction log file to a storage device.

15. A method for log compression in a file system, comprising:
receiving a log input; and
writing the log input in a statistically-determined compression format to a transaction log file if a size of the compressed log input is less than a size of the log input in an uncompressed format.

16. The method of claim 15, further comprising comparing the size of the compressed log input with the size of the uncompressed log input.

17. The method of claim 15, further comprising writing the log input to the transactional log file with an indicator indicating that the log input is compressed if the size of the compressed log input is less than the size of the uncompressed log input.

18. The method of claim 15, further comprising writing the size of the compressed log input to the transaction log file if the size of the compressed log input is less than the size of the uncompressed log input.

19. The method of claim 15, wherein receiving the log input comprises receiving an update for metadata associated with at least one file of the file system.

20. The method of claim 15, further comprising determining the statistically-determined compression format for compressing the log input from a plurality of received log inputs.

21. The method of claim 15, further comprising automatically changing the statistically-determined compression format used to compress the log input in response to a change in a frequency of occurrence of values associated with a plurality of received log inputs.

22. The method of claim 15, further comprising statistically analyzing a predetermined quantity of log inputs.

23. A system comprising application logic operable to:
receive a log input; and
write the log input to a transaction log file in a statistically-determined compression format.

24. The system of claim 23, the application logic operable to write the log input to the transaction log file with an indicator indicating that the log input is compressed.

25. The system of claim 23, the application logic operable to compare a size of the log input in the compressed format to a size of the log input in an uncompressed format.

26. The system of claim 23, the application logic operable to determine the statistically-determined compression format for the log input based at least in part on a plurality of received log inputs.

27. The system of claim 23, the application logic operable to receive an update for metadata associated with at least one file of said file system as the log input.

28. The system of claim 23, the application logic operable to divide the log input into a plurality of segments.

29. The system of claim 28, the application logic operable to update log statistics based at least in part on a value of each of the plurality of segments.

30. The system of claim 28, the application logic operable to replace at least one of the plurality of segments with another segment of smaller size.

31. The system of claim 28, the application logic operable to determine a value for each of the plurality of segments.

32. The system of claim 23, the application logic operable to suspend compression of the log input in response to a frequency of occurrence of values associated with a plurality of received log inputs exceeding a predetermined threshold.

33. The system of claim 23, the application logic operable to automatically changing the statistically-determined compression format after processing of the log input from the transaction log file to a storage device.

34. A system comprising application logic operable to:
receive a log input; and
write the log input in a statistically-determined compression format to a transaction log file if a size of the compressed log input is less than a size of the log input in an uncompressed format.

35. The system of claim 34, the application logic operable to compare the size of the compressed log input with the size of the uncompressed log input.

36. The system of claim 34, the application logic operable to write the log input to the transactional log file with an indicator indicating that the log input is compressed if the size of the compressed log input is less than the size of the uncompressed log input

37. The system of claim 34, the application logic operable to write the size of the compressed log input to the transaction log file if the size of the compressed log input is less than the size of the uncompressed log input.

38. The system of claim 34, the application logic operable to receive an update for metadata associated with at least one file of the file system as the log input.

39. The system of claim 34, the application logic operable to determine the statistically-determined compression format for compressing the log input from a plurality of received log inputs.

40. The system of claim 34, the application logic operable to automatically change the statistically-determined compression format used to compress the log input in response to a change in a frequency of occurrence of values associated with a plurality of received log inputs.

41. The system of claim 34, the application logic operable to automatically change the statistically-determined compression format used to compress the log input after processing of the log input to a storage device.

42. A dynamic log compression system, comprising:
means for receiving a log input; and
means for writing the log input to a transaction log file in a statistically-determined compression format.

43. The system of claim 42, further comprising means for determining the statistically-determined compression format for the log input based at least in part from a plurality of received log inputs.

44. The system of claim 42, further comprising means for automatically changing the statistically-determined compression format for compressing the log input in response to a change in a frequency of occurrence of values associated with a plurality of received log inputs.

45. The system of claim 42, further comprising means for comparing a size of the compressed log input with a size of the log input in an uncompressed format.

46. The system of claim 42, further comprising means for suspending compression of the log input in response to a frequency of occurrence of values associated with a plurality of received log inputs exceeding a predetermined threshold.

47. A method for log compression in a file system, comprising:
statistically determining a compression format for compressing at least one of a plurality of received log inputs in the file system; and
automatically changing the statistically-determined compression format if a frequency of occurrence of values associated with the plurality of received log inputs exceeds a predetermined threshold.

48. The method of claim 47, further comprising automatically suspending compression of the plurality of log inputs in response to the frequency exceeding the predetermined threshold.

49. The method of claim 47, further comprising suspending compression of the plurality of log inputs until the plurality of log inputs is processed to a storage device.

50. The method of claim 47, further comprising automatically storing a new statistically-determined compression format in a storage device after processing of the plurality of log inputs to the storage device.
